(19) United States
(12) Patent Application Publication
(10) Pub. No.: US 2025/0148435 A1
(43) Pub. Date: May 8, 2025

(54) Green Mining System for Distributed and Centralized Operations

(71) Applicant: Bank of America Corporation, Charlotte, NC (US)

(72) Inventors: Priyanka K, Chennai (IN); Durga Prasad Kutthumolu, Hyderabad (IN); Abhishek Arya, Hyderabad (IN); Subburathinam Krishnan, Chennai (IN)

(73) Assignee: Bank of America Corporation, Charlotte, NC (US)

(21) Appl. No.: 18/387,307

(22) Filed: Nov. 6, 2023

(51) Int. Cl. G06Q 20/06; G06Q 20/36; H04L 9/00

(52) U.S. Cl. CPC G06Q 20/065; G06Q 20/36; H04L 9/50; G06Q 2220/00; H04L 2209/56

(57) ABSTRACT

Systems and methods to enable green mining for centralized and/or decentralized financial systems are discussed. In some cases, the green mining methodologies are incorporated in distributed quantum ledger-based decentralized finance ecosystems, in decentralized financial systems and/or centralized financial systems. A proof of influence algorithm enables miners to accumulate and use reputation points to reduce computational power requirements on their systems and/or reduce energy consumptionInfluence points is an indicator of trustworthiness of the miner established based utilizing a predictive algorithm that analyzes the past mining behavior. Higher reputational scores result in lesser computationally intensive activities, which reduce energy consumption. The proof of influence algorithm rewards miners to encourage participation as validators of new blocks and/or other activities on the decentralized or centralized ledger-based systems.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

Distributed peer-to-peer systems, such as blockchains or other distributed ledger computing systems may be freely accessible, often without ownership from a single entity. A consensus mechanism is often used to coordinate the distributed peer-to-peer network. Consensus between different distributed parties involves coordinating the actions of different parties and agreeing on operations and decisions. For example, with a blockchain payments network, processing, settlement, and validation of transactions correctly prevents possible instances of double spending. As such, consensus is crucial to proper processing and settlement of transactions. As such, centralized and/or decentralized consensus processes are used to maintain integrity for the blockchain systems. Commonly used consensus mechanisms include, for example, Proof-of-Work (PoW), Proof-of-Stake (POS), designated PoS, and the like for public blockchain networks and practical Byzantine Fault Tolerance (pBFT), Istanbul BFT (iBFT), federated BFT (fBFT), DiemBFT, and proof of elapsed time, and the like for private blockchain networks.

A variety of consensus mechanisms are available, where some consensus processes may prioritize efficiency and speed while others may prioritize security. Different applications that leverage blockchain technologies may select a particular consensus process for a variety of reasons. Such decisions may be due to desire for faster consensus formation, more security, less power consumption, and the like.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes systems and processes for verification of blockchain transactions.

Aspects of the disclosure relate to computer hardware and software. In particular, one or more aspects of the disclosure generally relate to computer hardware and software for providing consensus-based verification of blockchain transactions in an energy and/or computational efficient manner.

The replacement of prevailing proof of work algorithm with a proof of influence (Pol) algorithm for mining, results in a major decrease in energy and computational power requirements. The proposed Pol algorithm can be incorporated and utilized in both centralized and decentralized networks, by substituting the conventional expensive mining operations (e.g., block validation activities). Additionally, the Pol algorithm may also be applied in quantum computing environments that may further enhance the existing computational process of quantum systems. The Pol algorithm is based on cryptographic techniques that allows miners to earn reputation (e.g., influence) points based on their past mining behavior. These reputation points (e.g., influence scores) can be used as a measure of trustworthiness. Miners with higher reputation scores can mine blocks with less computational power. Also, the algorithm incorporates certified mining, an extra layer of mining security that ensures miners are using the correct software and hardware and prevents attacks such as Sybil attacks.

Incorporating Proof of Influence (Pol) algorithm in a conventional computing environment and/or a quantum computing environment reduces clock cycles used for processing by the dedicated computing hardware and allow the computing hardware to dissipate less heat when used to mine a same amount of cryptocurrency as done with present computing technologies. The Pol algorithm may be applied in both centralized and decentralized finance systems. In some cases, the Pol algorithm may be used for processing electronic transactions (e.g., trades) in a distributed quantum ledger used in a decentralized finance ecosystem. A layer of security is affixed to certify that whoever benefits from any reputation bonus is the same virtual identity that has done the past work that provided the reputation.

Application of the Pol algorithm may be used with respect to crypto burning activities to reduce the supply of a given cryptocurrency and helps to increase value of the tokens in circulation. Typically, crypto burning activities result in an increase in mining activity and consumption of high computational resources. The Pol algorithm can be embedded in the computing frameworks for performance of fresh mining to reduce the overall carbon footprint. Additionally, a trust-based mechanism may be incorporated in a Centralized Finance (CeFi) system to reduce repetitive tasks and, in turn, reduce the computational and energy usage requirements to lead to a reduced carbon footprint. Further, the Pol algorithm may lead to a significant reduction in energy consumption in decentralize finance (DeFi) mining operations by replacing compute intensive protocols with POI algorithm.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative example of centralized computer system in accordance with one or more illustrative aspects described herein;

FIG. 2 shows an illustrative example of decentralized peer-to-peer (P2P) computer system that may be used in accordance with one or more illustrative aspects described herein;

FIG. 3A shows an illustrative example of a full node computing device that may be used in accordance with one or more illustrative aspects described herein;

FIG. 3B shows an illustrative example of a lightweight node computing device that may be used in accordance with one or more illustrative aspects described herein;

FIG. 4 shows an illustrative example of a suitable computing system environment that may be used in accordance with one or more illustrative aspects described herein;

FIG. 5A shows an illustrative computing environment for implementing a proof of influence consensus mechanism for block validation for blockchain computing systems, in accordance with one or more aspects described herein;

FIG. 5B shows an illustrative computing platform enabled for a proof of influence consensus mechanism for block validation for blockchain computing systems, in accordance with one or more aspects described herein;

FIGS. 6A and 6B show an illustrative process for a proof of influence consensus mechanism, in accordance with one or more aspects described herein;

FIG. 7 shows an illustrative proof of influence consensus mechanism computing system in accordance with one or more aspects described herein;

FIGS. 8 and 9 show aspects of an illustrative proof of influence consensus mechanism in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

As mentioned above, a distributed ledger computing system (e.g., a blockchain system, a Holochain system, and the like) is a peer-to-peer, distributed data repository that provides an immutable record of information. To add records to the distributed ledger such as a blockchain, consensus algorithms are used to decide how a subsequent block is added. For example, one several consensus models may be used to decide which competing node will publish a newly added block to a permissionless blockchain network. To incentivize node owners to add blocks, rewards may be provided. Consensus algorithms are often subject to multiple problems including technological issues, environmental issues (e.g., large energy use), and/or security issues. For example, consensus algorithms may be subject to node failure conditions, network segmentation, message delays, out-of-order message arrivals, and/or corrupted message attacks. Additionally, some nodes may be operated by malicious actors that may attempt improper activities with the distributed ledger.

To overcome certain issues, consensus algorithms have been developed to address certain safety, fault tolerance and/or energy use issues. However, current consensus algorithms may have security vulnerabilities and/or involve excessive energy usage. For example, as blockchain networks utilizing PoW and PoS are increasing in use, such distributed ledger systems face an increasing security risk as well as increasing their carbon footprint. For example, a PoW enabled system is causing serious computational usage, equipment shortages, and/or environmental concerns due to its large energy requirement keep that continues growing without any much restriction.

PoW is a consensus mechanism involving nodes solving complicated, asymmetrical mathematical puzzles to produce new blocks. In some cases, the distributed ledger computing system, centralized or decentralized, may adjust the difficulty of the mathematical puzzles. In some cases, the mathematical puzzle may be solved by multiple nodes, which may cause parallel blocks to be created in, for example, a blockchain. While solvable, the process of resolving the “forking” problem may involve additional computing power and time. Users associated with the nodes are incentivized to solve the puzzles by receiving a reward, where a size of the reward may increase the probability that the puzzle will be solved sooner, resulting in a faster transaction. Another potential concern with PoW methodology is that a single node may attempt to control the network to engage in fraudulent transactions. General openness on system participation can lead to regulatory and/or security problems. The competitive nature of solving the mathematical puzzles of PoW requires brute force calculations on multiple competing specialized computing systems, thus using a significant power requirement. Indeed, total energy usage in certain cryptocurrency markets is comparable to energy usage of a small country leading to environmental concerns.

Other validation methodologies (e.g., a proof of stake (POS) methodology) may include an algorithm to randomly select validators for block creation based on a stake amount provided by holders of a cryptocurrency. Often, a proposed block may be validated by stake holders with larger ownership. While PoS minimizes some problems encountered with PoW (e.g., large energy consumption), validating nodes might attempt to validate multiple blocks where some of the blocks underlying information may be incorrect, creating risks around overall integrity of the cryptocurrency exchange. Additionally, with multiple parties attempting to validate multiple blocks increases risks of forking, which in turn creates uncertainty with settlement finality. Additionally, weaknesses within the POS functionality may impact stability and integrity of the associated blockchains, such as by causing centralization of the decentralized peer-to-peer distributed ledger system. Additionally, PoS validators may be include a group of malicious actors that attempt to work collectively or larger holders of an associated cryptocurrency may be given deference, thus leading to disproportionate control over the distributed ledger system by the malicious actor group or larger stakeholders. As discussed, PoW and PoS may be subject to problems with significant energy consumption, the nature of forking, and other issues around probabilistic settlement. As such, a need has been recognized for an energy efficient and secure consensus mechanism for use in centralized and/or decentralized ledger computing systems.

The disclosure provided herein is described, at least in part, in relation to a decentralized peer-to-peer (e.g., P2P) system specialized for the purpose of managing a blockchain. The decentralized P2P system may be comprised of computing devices that are distributed in multiple locations across a geographical area as opposed to a single location. The computing devices forming the decentralized P2P system may operate with each other to manage a blockchain, which may be a data structure used to store information related to the decentralized P2P system. More specifically, the blockchain may be a chronological linkage of data elements (e.g., blocks) which store data records relating to the decentralized computing system.

A user may access the decentralized P2P system through a specialized “wallet” that serves to uniquely identify the user and enable the user to perform functions related to the decentralized P2P network. Through the wallet, the user may be able to hold tokens, funds, and/or any other asset associated with the decentralized P2P system. Furthermore, the user may be able to use the wallet to request performance of network-specific functions related to the decentralized P2P system such as fund, token, and/or asset transfers. The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

For example, a user may have a wallet which reflects that the user has five tokens associated with the decentralized P2P system. The user may provide a request to the decentralized P2P system to transfer the five tokens to a friend who also has a wallet. The various computing devices forming the decentralized P2P computing system may perform the request and transfer the five tokens from the wallet of the user to the wallet of the friend. In doing so, a block may be created by the various computing devices of the decentralized P2P computing system. The block may store data indicating that the five tokens were transferred from the wallet of the user to the wallet of the friend. The various computing devices may add the block to the blockchain. At such a point, the wallet of the user may reflect the transfer of the five tokens to the wallet of the friend, and may indicate a balance of zero. The wallet of the friend, however, may also reflect the transfer of the five tokens and may have a balance of five tokens.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P system (e.g., decentralized system) may be comprised of decentralized system infrastructure consisting of a plurality computing devices, either of a heterogeneous or homogenous type, which serve as network nodes (e.g., full nodes and/or lightweight nodes) to create and sustain a decentralized P2P network (e.g., decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network and aggregated through execution of the one or more digital cryptographic hash functions and by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a data ledger that stores records relating to a decentralized computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (e.g., IoT), prediction platforms, balloting, health records, currency exchange and remittance, P2P transfers, ride sharing, participatory electronic entertainment, trading platforms, and real estate, precious metal, and work of art registration and transference, among others. A “private blockchain” may refer to a blockchain of a decentralized private system in which only authorized computing devices are permitted to act as nodes in a decentralized private network and have access to the private blockchain. In some instances, the private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

Further, a “full node” or “full node computing device,” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device,” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations.” A smart contract operation, as used herein, may describe one or more operations performed by a “smart contract,” which may be one or more algorithms and/or programs associated with one or more nodes within a decentralized P2P network. For example, the one or more algorithms and/or programs may correspond to addition of a NFT-API to a blockchain or querying of NFT-APIs stored in a blockchain. Addition of NFT-APIs may correspond to updating those stored in the blockchain.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network. A wallet may be associated with a public key, which may serve to identify the wallet. In requesting performance of network operations, a private key associated with the wallet may be used to digitally sign the network operation requests.

As will be described in further detail below, a decentralized P2P system implementing a blockchain data structure may provide solutions to technological problems existing in current centralized system constructs with traditional data storage arrangements. For example, conventional data storage arrangements that use a central data authority have a single point of failure (namely, the central storage location) which, if compromised by a malicious attacker, can lead to data tampering, unauthorized data disclosure, and illicit use and/or loss of operative control of the processes performed by the centralized system. The implementation of a blockchain data structure in a decentralized P2P system acts as a safeguard against unreliable and/or malicious nodes acting in the decentralized P2P network to undermine the work efforts of the other nodes, e.g., by providing byzantine fault tolerance within the network.

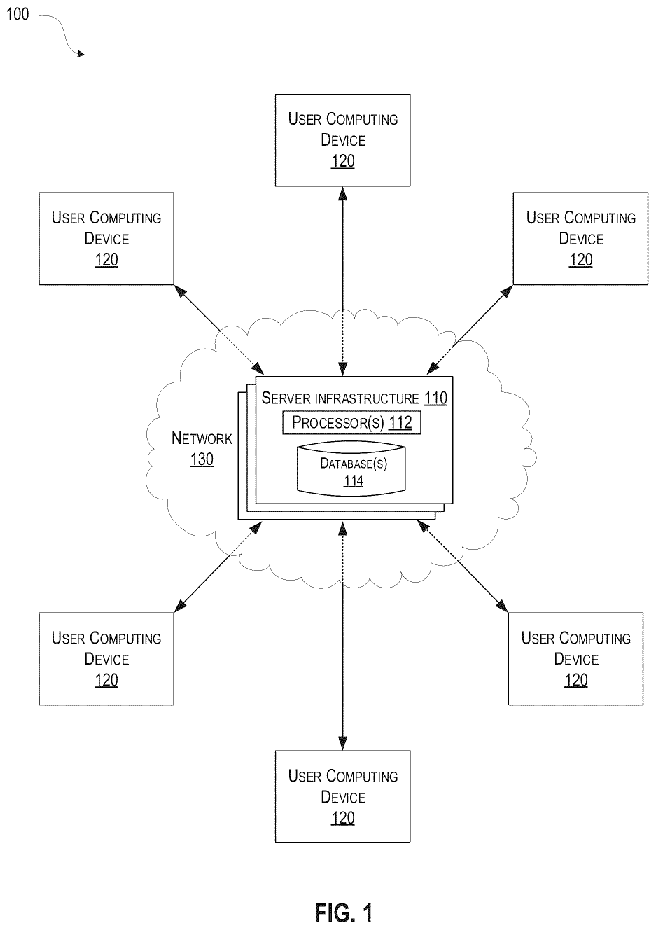

FIG. 1 depicts an illustrative example of centralized computer system 100 in accordance with one or more illustrative aspects described herein. Centralized computer system 100 may comprise one or more computing devices including at least server infrastructure 110 and user computing devices 120. Each of user computing devices 120 may be configured to communicate with server infrastructure 110 through network 130. In some arrangements, centralized computer system 100 may include additional computing devices and networks that are not depicted in FIG. 1, which also may be configured to interact with server infrastructure 110 and, in some instances, user computing devices 120.

Server infrastructure 110 may be associated with a distinct entity such as a company, school, government, and the like, and may comprise one or more personal computer(s), server computer(s), hand-held or laptop device(s), multiprocessor system(s), microprocessor-based system(s), set top box(es), programmable consumer electronic device(s), network personal computer(s) (PC), minicomputer(s), mainframe computer(s), distributed computing environment(s), and the like. Server infrastructure 110 may include computing hardware and software that may host various data and applications for performing tasks of the centralized entity and for interacting with user computing devices 120, as well as other computing devices. For example, each of the computing devices comprising server infrastructure 110 may include at least one or more processors 112 and one or more databases 114, which may be stored in memory of the one or more computing devices of server infrastructure 110. Through execution of computer-readable instructions stored in memory, the computing devices of server infrastructure 110 may be configured to perform functions of the centralized entity and store the data generated during the performance of such functions in databases 114.

In some arrangements, server infrastructure 110 may include and/or be part of enterprise information technology infrastructure and may host a plurality of enterprise applications, enterprise databases, and/or other enterprise resources. Such applications may be executed on one or more computing devices included in server infrastructure 110 using distributed computing technology and/or the like. In some instances, server infrastructure 110 may include a relatively large number of servers that may support operations of a particular enterprise or organization, such as a financial institution. Server infrastructure 110, in this embodiment, may generate a single centralized ledger for data received from the various user computing devices 120, which may be stored in databases 114.

Each of the user computing devices 120 may be configured to interact with server infrastructure 110 through network 130. In some instances, one or more of the user computing devices 120 may be configured to receive and transmit information corresponding to system requests through particular channels and/or representations of webpages and/or applications associated with server infrastructure 110. The system requests provided by user computing devices 120 may initiate the performance of particular computational functions such as data and/or file transfers at server infrastructure 110. In such instances, the one or more of the user computing devices may be internal computing devices associated with the particular entity corresponding to server infrastructure 110 and/or may be external computing devices which are not associated with the particular entity.

As stated above, centralized computer system 100 also may include one or more networks, which may interconnect one or more of server infrastructure 110 and one or more user computing devices 120. For example, centralized computer system 100 may include network 130. Network 130 may include one or more sub-networks (e.g., local area networks (LANs), wide area networks (WANs), or the like). Furthermore, centralized computer system 100 may include a local network configured to interlink each of the computing devices comprising server infrastructure 110.

Furthermore, in some embodiments, centralized computer system 100 may include a plurality of computer systems arranged in an operative networked communication arrangement with one another through a network, which may interface with server infrastructure 110, user computing devices 120, and network 130. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

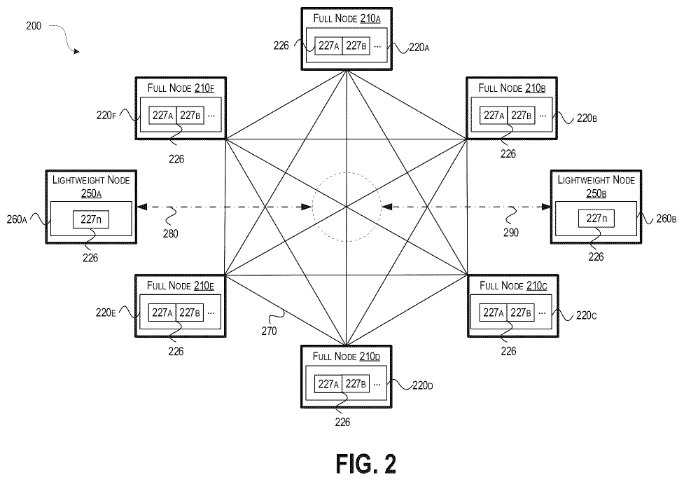

In the centralized computer system 100 described in regard to FIG. 1, server infrastructure 110 may serve as a central authority which manages at least a portion of the computing data and actions performed in relation to the particular entity associated with server infrastructure 110. As such, server infrastructure 110 of centralized computer system 100 provides a single point of failure which, if compromised by a malicious attacker, can lead to data tampering, unauthorized data disclosure, and illicit use and/or loss of operative control of the processes performed by the server infrastructure 110 in relation to the particular entity associated with server infrastructure 110. In such a centralized construct in which a single point of failure (e.g., server infrastructure 110) is created, significant technological problems arise regarding maintenance of operation and data control, as well as preservation of data integrity. As will be described in further detail below in regard to FIG. 2, such technological problems existing in centralized computing arrangements may be solved by a decentralized P2P system implementing a blockchain data structure, even wholly within the server infrastructure 110.

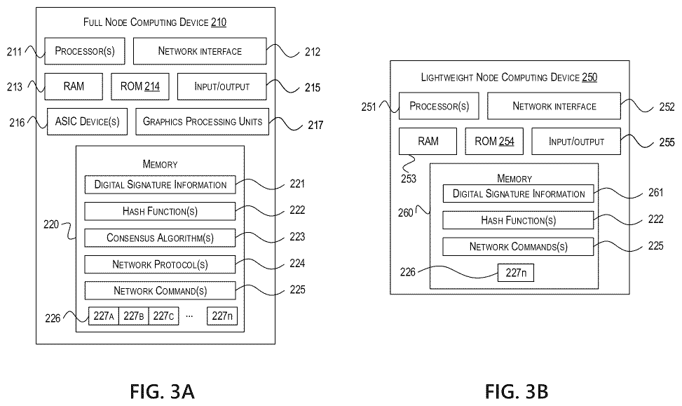

FIG. 2 depicts an illustrative example of decentralized P2P computer system 200 that may be used in accordance with one or more illustrative aspects described herein. Decentralized P2P computer system 200 may include a plurality of full node computing devices 210A, 210B, 210C, 210D, 210E, and 210F and lightweight node computing devices 250A and 250B, which may be respectively similar to full node computing device 210 described in regard to FIG. 3A and lightweight node computing device 250 described in regard to FIG. 3B. While a particular number of full node computing devices and lightweight node computing devices are depicted in FIG. 2, it should be understood that a number of full node computing devices and/or lightweight node computing devices greater or less than that of the depicted full node computing devices and lightweight node computing devices may be included in decentralized P2P computer system 200. Accordingly, any additional full node computing devices and/or lightweight node computing devices may respectively perform in the manner described below in regard to full node computing devices 210A-210F and lightweight node computing devices 250A and 250B in decentralized P2P computer system 200.

Each of full node computing devices 210A-210F may operate in concert to create and maintain decentralized P2P network 270 of decentralized P2P computer system 200. In creating decentralized P2P network 270 of decentralized P2P computer system 200, processors, ASIC devices, and/or graphics processing units (e.g., GPUs) of each full node computing device 210A-210F may execute network protocols which may cause each full node computing device 210A-210F to form a communicative arrangement with the other full node computing devices 210A-210F in decentralized P2P computer system 200 and thereby create decentralized P2P network 270. Furthermore, the execution of network protocols by the processors, ASIC devices, and/or GPUs of full node computing devices 210A-210F may cause full node computing devices 210A-210F to execute network functions related to blockchain 226 and maintain decentralized P2P network 270.

Lightweight node computing devices 250A and 250B may request execution of network functions related to decentralized P2P network 270. In order to request execution of network functions, such as balance sheet transaction and/or smart contract operations, processors of lightweight node computing devices 250A and 250B may execute network commands to broadcast the network functions to decentralized P2P network 270 comprising full node computing devices 210A-210F.

For example, lightweight node computing device 250A may request execution of a balance sheet transaction related to decentralized P2P network 270, which may entail a data transfer from a wallet associated with lightweight node computing device 250A to a wallet associated with lightweight node 250B. In doing so, processors of lightweight node computing device 250A may execute network commands to broadcast balance sheet transaction network function request 280 to decentralized P2P network 270. Balance sheet transaction network function request 280 may include details about the data transfer such as data type and amount, as well as a data transfer amount to full node computing devices 210A-201F of decentralized P2P network 270 for executing balance sheet transaction network function request 280. Balance sheet transaction network function request 280 may further include the public key associated with the wallet of lightweight node computing device 250B. Processors of lightweight node computing device 250A may execute digital signature algorithms to digitally sign balance sheet transaction network function request 280 with the private key associated with the wallet of lightweight node computing device 250A.

At decentralized P2P network 270, balance sheet transaction network function request 280 may be broadcasted to each of full node computing devices 210A-210F through execution of network protocols by full node computing devices 210A-210F. In order to execute balance sheet transaction network function request 280 and maintain inter-nodal agreement as to the state of blockchain 226, processors, ASIC devices, and/or GPUs of full node computing devices 210A-210F may execute network protocols to receive broadcast of the network function through decentralized P2P network 270 and from lightweight node computing device 250A. Processors, ASIC devices, and/or GPUs of full node computing devices 210A-210F may execute hash functions to generate a digest of balance sheet transaction network function request 280. The resultant digest of balance sheet transaction network function request 280 may, in turn, be hashed with the block hash of the most immediately preceding block of blockchain 226. Processors, ASIC devices, and/or GPUs of full node computing devices 210A-210F may execute consensus algorithms to identify a numerical value (e.g., nonce) corresponding to the particular executed consensus algorithm and related to the digest that combines the digest of the balance sheet transaction network function request 280 and the block hash of the most immediately preceding block of blockchain 226.

For example, in embodiments in which the consensus algorithm is proof of work (e.g., PoW), processors, ASIC devices, and/or GPUs of full node computing devices 210A-210F may perform a plurality of hashing operations to identify a nonce that, when hashed with the digest that combines the digest of the balance sheet transaction network function request 280 and the block hash of the most immediately preceding block of blockchain 226, produces a hash of a predetermined alphanumerical format. Such a predetermined alphanumerical format may include a predetermined number of consecutive alphanumerical characters at a predetermined position within the resultant digest that combines the nonce, digest of the balance sheet transaction network function request 280, and block hash of the most immediately preceding block of blockchain 226.

In embodiments in which the consensus algorithm is proof of stake (e.g., PoS), a private key associated with one of full node computing devices 210A-210F may be pseudo-randomly selected, based on balance sheet holdings associated with the public keys of full node computing devices 210A-210F, to serve as the nonce. For example, through execution of the POS consensus algorithm, full node computing devices 210A-210F are entered into a lottery in which the odds of winning are proportional to a balance sheet amount associated the wallet of each of full node computing devices 210A-210F, wherein a larger balance sheet amount corresponds to a higher probability to win the lottery. The PoS consensus algorithm may cause a full node computing device from full node computing devices 210A-210F to be selected, and the public key of the wallet of the selected full node computing device to be used as the nonce.

In embodiments in which the consensus algorithm is delegated proof of stake (e.g., DpoS), a group of delegates are chosen from full node computing devices 210A-210F by each of computing devices 210A-210F, wherein full node computing devices 210A-210F are allowed to select candidate delegates based on balance sheet holdings associated with the respective wallets. Full node computing devices 210A-210F, however, may not select themselves to be delegates. Once the group of delegates are chosen, the group of delegates from full node computing devices 210A-210F select a public key associated with a wallet of one of full node computing devices 210A-210F to serve as the nonce.

In embodiments in which the consensus algorithm is practical byzantine fault tolerance algorithm (e.g., PBFT), each of full node computing devices 210A-210F are associated with a particular status and/or ongoing specific information associated with the respective public key of the full node computing devices. Each of full node computing devices 210A-210F receive a message through decentralized P2P network 270 based on network protocols. Based on the received message and particular status and/or ongoing specific information, each of full node computing devices 210A-210F perform computational tasks and transmit a response to the tasks to each of the other full node computing devices 210A-210F. A public key of a wallet associated with a particular full node computing device from full node computing devices 210A-210F is selected by each of full node computing devices 210A-210F based on the response of the particular full node computing device best fulfilling criteria determined based on the network protocols.

The identification of the nonce enables processors, ASIC devices, and/or GPUs of the full node computing device from full node computing devices 210A-210F corresponding to the nonce to create a new block with a block header (e.g., block hash), which is a digest that combines the digest of balance sheet transaction network function request 280, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may be allowed, per the network protocols, to increase balance sheet holdings associated with itself by a predetermined amount. In some arrangements, each of full node computing devices 210A-210F may receive an equal portion of the data transfer amount specified by lightweight node computing device 250A for executing balance sheet transaction network function request 280. After the new block has been added to blockchain 226, balance sheet transaction network function request 280 may be considered to be executed and the data transfer from the wallet associated with lightweight node computing device 250A to the wallet associated with lightweight node 250B may be registered.

As stated above, in some arrangements, a plurality of network function requests may be broadcasted across decentralized network P2P network 270. Processors, ASIC devices, and/or GPUs of full node computing devices 210A-210F may execute network protocols to receive broadcast of each of the network functions, including balance sheet transaction network function request 280, through decentralized P2P network 270 and from the requesting entities, including lightweight node computing device 250A. Processors, ASIC devices, and/or GPUs of full node computing devices 210A-210F may execute hash functions to generate a hash tree (e.g., Merkle tree) of the requested network functions, which culminates in a single digest (e.g., root digest, root hash, and the like) that comprises the digests of each of the requested network functions, including balance sheet transaction network function request 280. The root digest of the requested network function may, in turn, be hashed with the block hash of the most immediately preceding block of blockchain 226. Processors, ASIC devices, and/or GPUs of full node computing devices 210A-210B may execute consensus algorithms in the manner described above to identify a nonce corresponding to the particular executed consensus algorithm and related to the digest that combines the root digest of the requested network functions and the block hash of the most immediately preceding block of blockchain 226. The identification of the nonce enables processors, ASIC devices, and/or GPUs of the full node computing device from full node computing devices 210A-210F to create a new block with a block header (e.g., block hash), which is a digest that combines the root digest of the network function requests, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may be allowed, per the network protocols, to increase a balance sheet holdings amount associated with itself by a predetermined amount. In some arrangements, each of full node computing devices 210A-210F may receive an equal portion of the data transfer amount specified by each of the network function requests. After the new block has been added to blockchain 226, each of the network functions requests, including balance sheet transaction network function request 280, may be considered to be executed and the data transfer from the private/public key associated with lightweight node computing device 250A to the private/public key associated with lightweight node 250B may be registered.

While the description provided above is made in relation to a balance sheet transaction involving lightweight node computing device 250A and lightweight node computing device 250B, it is to be understood that balance sheet transactions are not limited to lightweight node computing device 250A and lightweight node computing device 250B, but rather may be made across any of the full node computing devices and/or lightweight node computing devices in decentralized P2P system 200.

For another example, lightweight node computing device 250B may request a smart contract operation related to decentralized P2P network 270, which may facilitate a dual data transfer between a wallet associated with lightweight node computing device 250B and a wallet associated with another node in decentralized P2P network 270, such as lightweight node computing device 250A, based on fulfillment of programmatic conditions established by a smart contract. Processors of lightweight node computing device 250B may execute network commands to broadcast smart contract operation network function request 290 to decentralized P2P network 270. Smart contract operation network function request 290 may include details about the data transfer such as data type and amount, as well as a data transfer amount to full node computing devices 210A-210F of decentralized P2P network 270 for executing the smart contract corresponding to smart contract operation network function request 290. Smart contract operation network function request 290 may further include the public key associated with the smart contract. Processors of lightweight node computing device 250B may execute digital signature algorithms to digitally sign smart contract operation network function request 290 with the private key associated with the wallet of lightweight node computing device 250B.

At decentralized P2P network 270, smart contract operation network function request 290 may be broadcasted to each of full node computing devices 210A-210F through execution of network protocols by full node computing devices 210A-210F. In order to execute smart contract operation network function request 290 and maintain inter-nodal agreement as to the state of blockchain 226, processors, ASIC devices, and/or GPUs of full node computing devices 210A-210F may execute network protocols to receive broadcast of the network function through a decentralized P2P network 270 and from lightweight node computing device 250B. Processors, ASIC devices, and/or GPUs of full node computing devices 210A-210F may execute hash functions to generate a digest of smart contract operation network function request 290. The resultant digest of smart contract operation network function request 290, in turn, may be hashed with the block hash of the most immediately preceding block of blockchain 226. Processors, ASIC devices, and/or GPUs of full node computing devices 210A-210F may execute consensus algorithms to identify a nonce corresponding to the particular executed consensus algorithm and related to the digest that combines the digest of smart contract operation network function request 290 and the block hash of the most immediately preceding block of blockchain 226.

The identification of the nonce enables processors, ASIC devices, and/or GPUs of the full node computing device from full node computing devices 210A-210F to create a new block with a block header (e.g., block hash), which is a digest that combines smart contract operation network function request 290, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may, per the network protocols, increase a balance sheet holdings amount associated with itself by a predetermined amount. In some arrangements, each of full node computing devices 210A-210F may receive an equal portion of the data transfer amount specified by lightweight node computing device 250B for executing smart contract operation network function request 290. After the new block has been added to blockchain 226, smart contract operation request 290 may be considered to be executed and the data transfer from the wallet associated with lightweight node computing device 250B to the public key associated with the smart contract may be registered.

The smart contract may be configured to hold the data transfer from the wallet associated with lightweight node computing device 250B until fulfillment of certain predetermined criteria hardcoded into the smart contract are achieved. The smart contract may be configured such that it serves as an intermediate arbiter between entities within the decentralized P2P network 270 and may specify details of a dual data transfer between entities.

For example, the smart contract corresponding to smart contract operation request 290 may be one or more algorithms and/or programs stored on a block of blockchain 226. The smart contract may be identified by one or more wallets and/or public keys within decentralized P2P network 270. Lightweight node computing device 250B may transmit smart contract operation network function request 290 to decentralized P2P network 270, which may cause execution of the corresponding smart contract that facilitates a dual data transfer between a wallet associated with lightweight node computing device 250B and a wallet associated with another node in decentralized P2P network 270, such as lightweight node computing device 250A, based on fulfillment of programmatic conditions established by the smart contract. In the processes of adding the block comprising smart contract operation request 290 to blockchain 226, each of full node computing devices 210A-210F may identify the block within blockchain 226 comprising the smart contract, associate the data transfer entailed by smart contract operation request 290 with the smart contract, and execute the one or more algorithms and/or programs of the smart contract. In this instance, given that the smart contract facilitates a dual data transfer and that data transfer has yet to be received from another node (e.g., lightweight node computing device 250A), each of full node computing devices 210A-210F may execute the smart contract without fulfillment of the programmatic conditions established by the smart contract. Accordingly, the funds transferred by lightweight node computing device 250B may remain in the smart contract until the data transfer from the other node is also associated with the smart contract.

Moving forward, lightweight node computing device 250A may also request a smart contract operation related to decentralized P2P network 270, which may conclude the dual data transfer between the wallet associated lightweight node computing device 250A and the wallet associated with lightweight node computing device 250B. Processors of lightweight node computing device 250A may execute network commands to broadcast the smart contract operation network function request to decentralized P2P network 270. The smart contract operation network function request may include details about the data transfer such as data type and amount, as well as a data transfer amount to full node computing devices 210A-210F of decentralized P2P network 270 for executing the smart contract corresponding to the smart contract operation network function request. The smart contract operation network function request may further include the public key associated with the smart contract. Processors of lightweight node computing device 250A may execute digital signature algorithms to digitally sign the smart contract operation network function request with the private key associated with the wallet of lightweight node computing device 250A.

At decentralized P2P network 270, the smart contract operation network function request may be broadcasted to each of full node computing devices 210A-210F through execution of network protocols by full node computing devices 210A-210F. In order to execute the smart contract operation network function request and maintain inter-nodal agreement as to the state of blockchain 226, processors, ASIC devices, and/or GPUs of full node computing devices 210A-210F may execute network protocols to receive broadcast of the network function through a decentralized P2P network 270 and from lightweight node computing device 250A. Processors, ASIC devices, and/or GPUs of full node computing devices 210A-210F may execute hash functions to generate a digest of the smart contract operation network function request. The resultant digest of the smart contract operation network function request, in turn, may be hashed with the block hash of the most immediately preceding block of blockchain 226. Processors, ASIC devices, and/or GPUs of full node computing devices 210A-210F may execute consensus algorithms to identify a nonce corresponding to the particular executed consensus algorithm and related to the digest that combines the digest of the smart contract operation network function request and the block hash of the most immediately preceding block of blockchain 226.

The identification of the nonce enables processors, ASIC devices, and/or GPUs of the full node computing device from full node computing devices 210A-210F to create a new block with a block header (e.g., block hash), which is a digest that combines the smart contract operation network function request, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may be allowed, per the network protocols, to increase a balance sheet holdings amount associated with itself by a predetermined amount. In some arrangements, each of full node computing devices 210A-210F may receive an equal portion of the data transfer amount specified by lightweight node computing device 250A for executing the smart contract operation network function request. After the new block has been added to blockchain 226, the smart contract operation transaction network function request 290 may be considered to be executed and the data transfer from the wallet associated with lightweight node computing device 250A to the public key associated with the smart contract may be registered.

When the smart contract receives the data value from each of lightweight node computing device 250A and lightweight node computing device 250B, the execution of the smart contract by each of full node computing devices 210A-210F may cause transfer of the data value from lightweight node computing device 250A to lightweight node computing device 250B and the data value from lightweight node computing device 250B to lightweight node computing device 250A.

For example, lightweight node computing device 250A may transmit the smart contract operation network function request to decentralized P2P network 270, which may cause execution of the corresponding smart contract that facilitates the dual data transfer. In the process of adding the block comprising the smart contract operation request provided by lightweight node computing device 250A to blockchain 226, each of full node computing devices 210A-210F may identify the block within blockchain 226 comprising the smart contract, associate the data transfer entailed by smart contract operation request of lightweight node computing device 250A with the smart contract, and execute the one or more algorithms and/or programs of the smart contract. In this instance, given that the smart contract facilitates a dual data transfer and that data transfers have been received from lightweight node computing device 250A and lightweight node computing device 250B, each of full node computing devices 210A-210F may execute the smart contract as fulfillment of the programmatic conditions established by the smart contract has occurred. Accordingly, the funds allocated to the smart contract by each of lightweight node computing device 250A and lightweight node computing device 250B may be respectively distributed to the intended counterparty.

While the description provided above was made in relation to lightweight node computing device 250A and lightweight node computing device 250B, it should be understood that any of the full node computing devices and lightweight node computing devices in decentralized system 200 may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer. Other smart contracts may be included which include algorithms, programs, and/or computer-executable instructions which cause the performance of one or more functions related to at least cryptocurrency, digital content storage and delivery, entity authentication and authorization, digital identity, marketplace creation and operation, internet of things (e.g., IoT), prediction platforms, balloting, health records, currency exchange and remittance, P2P transfers, ride sharing, participatory electronic entertainment, trading platforms, and real estate, precious metal, and work of art registration and transference.

In comparison to the centralized computing system 100 described in regard to FIG. 1, decentralized P2P computer system 200 may provide technological advantages. For example, by distributing storage of blockchain 226 across multiple full node computing devices 210A-210F, decentralized P2P computer system 200 may not provide a single point of failure for malicious attack. In the event that any of the full node computing devices 210A-210F are compromised by a malicious attacker, decentralized P2P computer system 200 may continue to operate unabated as data storage of blockchain 226 and performance of network processes are not controlled by a singular entity such as server infrastructure 110 of centralized computing system 100.

Furthermore, by utilizing blockchain data structure 226, decentralized P2P system 200 may provide technological improvements to conventional decentralized P2P systems in regard to byzantine fault tolerance stemming from an unreliable and/or malicious full node acting in decentralized P2P network 270 to undermine the work efforts of the other nodes. For example, in coordinating action between full node computing devices 210A-210F in relation to a similar computational task (e.g., consensus algorithm), a malicious node would need to have computational power greater than the combined computational power of each of the other full node computing devices in decentralized P2P network 270 to identify the nonce and thereby be able to modify blockchain 226. As such, the likelihood that a malicious node could subvert decentralized P2P network 270 and enter falsified data into blockchain 226 is inversely proportional to the total computational power of decentralized P2P system 200. Therefore, the greater the total computational power of decentralized P2P system 200, the less likely that a malicious node could subvert decentralized P2P network 270 and undermine blockchain 226.

FIG. 3A depicts an illustrative example of a full node computing device 210 that may be used in accordance with one or more illustrative aspects described herein. Full node computing device 210 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, full node computing device 210 may be configured to operate in a decentralized P2P network and may request execution of network functions and/or to execute requested network functions and maintain inter-nodal agreement as to the state of a blockchain of the decentralized P2P network.

Full node computing device 210 may include one or more processors 211, which control overall operation, at least in part, of full node computing device 210. Full node computing device 210 may further include random access memory (RAM) 213, read only memory (ROM) 214, network interface 212, input/output interfaces 215 (e.g., keyboard, mouse, display, printer, and the like), and memory 220. Input/output (I/O) 215 may include a variety of interface units and drives for reading, writing, displaying, and/or printing data or files. In some arrangements, full node computing device 210 may further comprise specialized hardware components such as application-specific integrated circuit (e.g., ASIC) devices 216 and/or graphics processing units (e.g., GPUs) 217. Such specialized hardware components may be used by full node computing device 210 in performing one or more of the processes involved in the execution of requested network functions and maintenance of inter-nodal agreement as to the state of a blockchain. Full node computing device 210 may further store in memory 220 operating system software for controlling overall operation of the full node computing device 210, control logic for instructing full node computing device 210 to perform aspects described herein, and other application software providing secondary, support, and/or other functionality which may or might not be used in conjunction with aspects described herein.

Memory 220 may also store data and/or computer executable instructions used in performance of one or more aspects described herein. For example, memory 220 may store digital signature information 221 and one or more hash functions 222, consensus algorithms 223, network protocols 224, and network commands 225. In some arrangements, digital signature information 221, hash functions 222, and/or network commands 225 may comprise a wallet of full node computing device 210. Memory 220 may further store blockchain 226. Each of digital signature information 221, hash functions 222, consensus algorithms 223, network protocols 224, and network commands 225 may be used and/or executed by one or more processors 211, ASIC devices 216, and/or GPUs 217 of full node computing device 210 to create and maintain a decentralized P2P network, request execution of network functions, and/or execute requested network functions and maintain inter-nodal agreement as to the state of blockchain 226.

For example, in order to create and maintain a decentralized P2P network, processors 211, ASIC devices 216, and/or GPUs 217 of full node computing device 210 may execute network protocols 225. Execution of network protocols 225 may cause full node computing device 210 to form a communicative arrangement with other full node computing devices and thereby create a decentralized P2P network. Furthermore, the execution of network protocols 225 may cause full node computing device 210 to maintain the decentralized P2P network through the performance of computational tasks related to the execution of network requests related to a blockchain such as blockchain 226. As will be described in detail below, the execution of such computational tasks (e.g., hash functions 222, consensus algorithms 223, and the like) may cause full node computing device 210 to maintain inter-nodal agreement as to the state of a blockchain with other full node computing devices comprising the decentralized P2P network.

In order to request execution of network functions, such as smart contract operations, processors 211, ASIC devices 216, and/or GPUs 217 of full node computing device 210 may execute network commands 225 to broadcast the network function to a decentralized P2P network comprising a plurality of full nodes and/or lightweight nodes. The request may be digitally signed by full node computing device 210 with usage of the private/public key information and through execution of the digital signature algorithms of digital signature information 221.

In order to execute requested network functions and maintain inter-nodal agreement as to the state of a blockchain, processors 211, ASIC devices 216, and/or GPUs 217 of full node computing device 210 may execute network protocols 224 to receive a broadcast of a requested network function through a decentralized P2P network and from a requesting entity such as a full node or lightweight node. Processors 211, ASIC devices 216, and/or GPUs 217 of full node computing device 210 may execute hash functions 222 to generate a digest of the requested network function. The resultant digest of the requested network function, in turn, may be hashed with the block hash of the most immediately preceding block of the blockchain. As will be described in further detail below, processors 211, ASIC devices 216, and/or GPUs 217 of full node computing device 210 may execute consensus algorithms 223 to identify a numerical value (e.g., nonce) corresponding to the particular executed consensus algorithm and related to the digest that combines the digest of the requested network function and the block hash of the most immediately preceding block of the blockchain. The identification of the numerical value enables processors 211, ASIC devices 216, and/or GPUs 217 of full node computing device 210 to create a new block with a block header (e.g., block hash), which is a digest that combines the digest of the requested network function, the block hash of the most immediately preceding block, and the identified nonce. Processors 211, ASIC devices 216, and/or GPUs 217 of full node computing device 210 may add the new block to the blockchain based on network protocols 224 and broadcast the new block to the other nodes in the decentralized P2P network.

As stated above, in some arrangements, a plurality of network function requests may be broadcasted across the decentralized P2P network. Processors 211, ASIC devices 216, and/or GPUs 217 of full node computing device 210 may execute network protocols 224 to receive broadcast of each of the network functions through the decentralized P2P network and from the requesting entities. Processors 211, ASIC devices 216, and/or GPUs 217 of full node computing device 210 may execute hash functions 222 to generate a hash tree (e.g., Merkle tree) of the requested network functions, which culminates in a single digest (e.g., root digest, root hash, and the like) that comprises the digests of each of the requested network functions. The root digest of the requested network function, in turn, may be hashed with the block hash of the most immediately preceding block of the blockchain. Processors 211, ASIC devices 216, and/or GPUs 217 of full node computing device 210 may execute consensus algorithms 223 to identify a numerical value (e.g., nonce) corresponding to the particular executed consensus algorithm and related to the digest that combines the root digest of the requested network functions and the block hash of the most immediately preceding block of the blockchain. The identification of the numerical value enables processors 211, ASIC devices 216, and/or GPUs 217 of full node computing device 210 to create a new block with a block header (e.g., block hash), which is a digest that combines the root digest of the requested network functions, the block hash of the most immediately preceding block, and the identified nonce. Processors 211, ASIC devices 216, and/or GPUs 217 of full node computing device 210 may add the new block to the blockchain based on network protocols 224 and broadcast the new block to the other nodes in the decentralized P2P network.

Furthermore, memory 220 of full node computing device 210 may store blockchain 226. Blockchain 226 may include a blocks 227A, 227B, 227C, . . . 227n, wherein block 227A represents the first block (e.g., genesis block) of blockchain 226 and block 227n represents the most immediate block of blockchain 226. As such, the blockchain 226, which may be a replica or copy of the blockchain of the decentralized P2P network in which full node computing device 210 operates, may be a full or complete copy of the blockchain of the decentralized P2P network. Each of the blocks within blockchain 226 may include information corresponding to the one or more network functions executed by the decentralized P2P network. As such, blockchain 226 as stored in memory 220 of full node computing device 210 may comprise the totality of network functions executed by the decentralized network.

FIG. 3B depicts an illustrative example of a lightweight node computing device 250 that may be used in accordance with one or more illustrative aspects described herein. Lightweight node computing device 250 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, lightweight node computing device 250 may operate in a decentralized P2P network and may be configured to request execution of network functions through the decentralized P2P network. As such, lightweight node computing device 250 may be different than full node computing device 210 in that it is not configured to execute network functions and/or operate to maintain a blockchain of a decentralized P2P network. In other aspects, lightweight node computing device 250 may have substantially the same physical configuration as full node computing device 210, but configured with different programs, software, and the like.

Lightweight node computing device 250 may include one or more processors 251, which control overall operation of lightweight node computing device 250. Lightweight node computing device 250 may further include random access memory (RAM) 253, read only memory (ROM) 254, network interface 252, input/output interfaces 255 (e.g., keyboard, mouse, display, printer, and the like), and memory 260. Input/output (I/O) 255 may include a variety of interface units and drives for reading, writing, displaying, and/or printing data or files. Lightweight node computing device 250 may store in memory 260 operating system software for controlling overall operation of the lightweight node computing device 250, control logic for instructing lightweight node computing device 250 to perform aspects described herein, and other application software providing secondary, support, and/or other functionality which may or might not be used in conjunction with aspects described herein.

In comparison to full node computing device 210, lightweight node computing device 250 might not include, in some instances, specialized hardware such as ASIC devices 216 and/or GPUs 217. Such is the case because lightweight node computing device 250 might not be configured to execute network functions and/or operate to maintain a blockchain of a decentralized P2P network as is full node computing device 210. However, in certain arrangements, lightweight node computing device 250 may include such specialized hardware.

Memory 260 of lightweight node computing device 250 may also store data and/or computer executable instructions used in performance of one or more aspects described herein. For example, memory 260 may store digital signature information 261 and one or more hash functions 222 and network commands 225. In some arrangements, digital signature information 261, hash functions 222, and/or network commands 225 may comprise a wallet of lightweight node computing device 250. Each of hash functions 222 and network commands 225 stored in memory 260 of lightweight node computing device 250 may be respectively similar and/or identical to hash functions 222 network commands 225 stored in memory 220 of full node computing device 210.

In regard to the digital signature information, each of digital signature information 261 stored in memory 260 of lightweight node computing device 250 and digital signature information 221 stored in memory 220 of full node computing device 210 may comprise similar and/or identical digital signature algorithms. However, the private/public key information of digital signature information 261 stored in memory 260 of lightweight node computing device 250 may be different than that of the private/public key information of digital signature information 221 stored in memory 220 of full node computing device 210. Furthermore, the private/public key information of each node, whether full or lightweight, in a decentralized P2P computing network may be unique to that particular node. For example, a first node in a decentralized P2P computing network may have first private/public key information, a second node may have second private/public key information, a third node may have third private/public key information, and so on, wherein each of the private/public key information is unique to the particular node. As such, the private/public key information may serve as a unique identifier for the nodes in a decentralized P2P computing network.

Each of digital signature information 261, hash functions 222, and network commands 225 may be used and/or executed by one or more processors 251 of lightweight node computing device 250 to request execution of network functions in a decentralized P2P network. For example, in order to request execution of network functions, such as smart contract operations, processors 251 of lightweight node computing device 250 may execute network commands 225 to broadcast the network function to a decentralized P2P network comprising a plurality of full nodes and/or lightweight nodes. The request may be digitally signed by lightweight node computing device 250 with usage of the private/public key information and through execution of the digital signature algorithms of digital signature information 261.

Furthermore, memory 260 of lightweight node computing device 250 may store blockchain 226. Blockchain 226 stored in memory 260 of lightweight node computing device 250 may include at least block 227n, wherein block 227n represents the most immediate block of blockchain 226. As such, the blockchain 226, which may be a replica or copy of the blockchain of the decentralized P2P network in which lightweight node computing device 250 operates, may be a partial or incomplete copy of the blockchain of the decentralized P2P network. In some instances, however, blockchain 226 may include a blocks 227A, 227B, 227C, . . . 227n, wherein block 227A represents the first block (e.g., genesis block) of blockchain 226 and block 227n represents the most immediate block of blockchain 226. As such, the blockchain 226 may be a full or complete copy of the blockchain of the decentralized P2P network. Each of the blocks within blockchain 226 may include information corresponding to the one or more network functions executed by the decentralized P2P network.

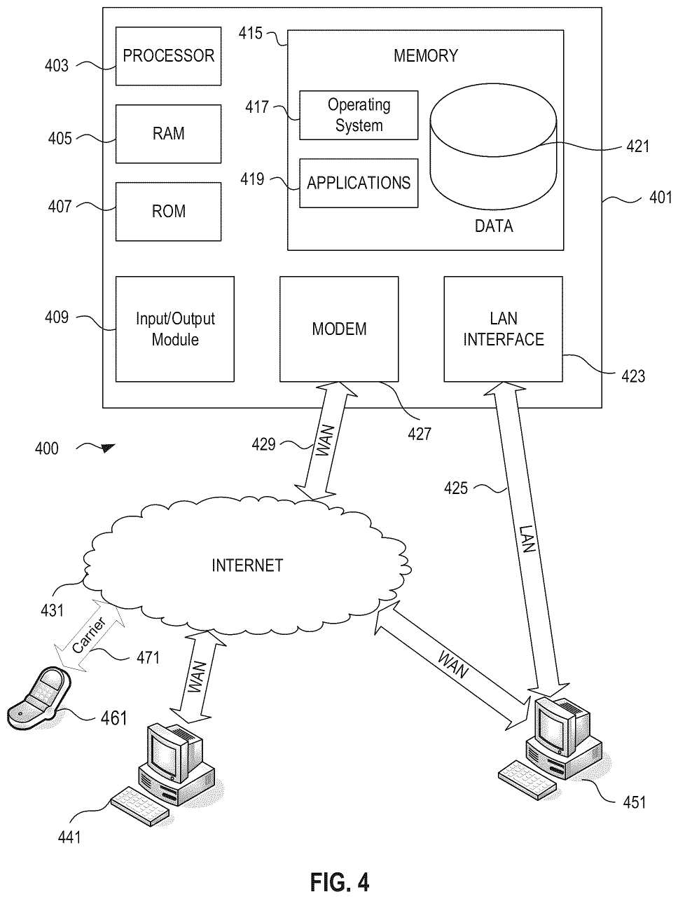

FIG. 4 illustrates an example of a computing system environment 400 that may be used according to one or more illustrative embodiments. The computing system environment 400 is only one example of a suitable computing environment and is not intended to suggest any limitation as to the scope of use or functionality contained in the disclosure. The computing system environment 400 should not be interpreted as having any dependency or requirement relating to any one or combination of components shown in the computing system environment 400.

The disclosure is operational with numerous other general purpose or special purpose computing system environments or configurations. Examples of computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 4, the computing system environment 400 may include a computing device 401 wherein the processes discussed herein may be implemented. The computing device 401 may have a processor 403 for controlling overall operation of the computing device 401 and its associated components, including random-access memory (RAM) 405, read-only memory (ROM) 407, input/output module or communications module 409, and memory 415. Computing device 401 typically includes a variety of computer readable media. Computer readable media may be any available media that may be accessed by computing device 401 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 401.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 400 may also include optical scanners (not shown). Exemplary usages include scanning and converting paper documents, e.g., correspondence, receipts to digital files.

Although not shown, RAM 405 may include one or more applications representing the application data stored in RAM 405, while the computing device is on and corresponding software applications (e.g., software tasks) are running on the computing device 401.

Communications module 409 may include a microphone, keypad, touch screen, and/or stylus through which a user of computing device 401 may provide input, and may also include one or more of a speaker for providing audio output and a video display device for providing textual, audiovisual and/or graphical output.

Software may be stored within memory 415 and/or storage to provide instructions to processor 403 for enabling computing device 401 to perform various functions. For example, memory 415 may store software used by the computing device 401, such as an operating system 417, application programs 419, and an associated database 421. Also, some or all of the computer executable instructions for computing device 401 may be embodied in hardware or firmware.

Computing device 401 may operate in a networked environment supporting connections to one or more remote computing devices, such as computing devices 441, 451, and 461. The computing devices 441, 451, and 461 may be personal computing devices or servers that include many or all of the elements described above relative to the computing device 401. Computing device 461 may be a mobile device communicating over wireless carrier channel 471.

The network connections depicted in FIG. 4 include a local area network (LAN) 425 and a wide area network (WAN) 429, but may also include other networks. When used in a LAN networking environment, computing device 401 may be connected to the LAN 425 through a network interface, such as LAN interface 423, or to an adapter in the communications module 409. When used in a WAN networking environment, the computing device 401 may include a modem in the communications module 409, a modem separate from the communications module 409, such as modem 427, or other means for establishing communications over the WAN 429, such as the Internet 431 or other type of computer network. It will be appreciated that the network connections shown are illustrative and other means of establishing a communication link between the computing devices may be used. Various protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 419 used by the computing device 401, according to an illustrative embodiment, may include computer executable instructions for invoking user functionality related to communication including, for example, email, short message service (SMS), and voice input and speech recognition applications. Embodiments of the disclosure may include forms of computer-readable media. Computer-readable media include any available media that can be accessed by a computing device 401. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 401. Such a processor may execute computer-executable instructions stored on a computer-readable medium. In an example, the systems and apparatus described herein may correspond to the computing device 401. A computer-readable medium (e.g., ROM 407) may store instructions that, when executed by the processor 403, may cause the computing device 401 to perform the functions as described herein.

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

Use of decentralized finance systems are on the rise. Such decentralized finance systems are based on distributed ledgers and are used to provide a fully digital transaction alternative without any associated costs, that could result in more open, free, and fair financial market system for anyone with an internet connection. However current implementations of decentralized finance systems include a significant downfall—the use of energy-intensive proof of work (PoW) systems that depend on mining to validate blocks and transactions. This traditional PoW functionality causes computing devices competing to solve the PoW puzzle to consume large amounts of computational power and large amounts of energy.

Proof of work is a consensus algorithm that requires miners to solve computationally intensive puzzles to validate transactions and add blocks to the blockchain. However, the energy consumption of PoW mining is a major concern due to its environmental impact (e.g., high energy costs) and high costs of equipment and components due to the ever-increasing computational power requirements to solve the puzzles. For example, the current validation techniques cause many challenges to the industries reliant upon electronic transaction use. Crypto mining alone is estimated to use approximately 100 terawatt-hours of electricity every year, which is more than the amount of energy used in countries such as Finland. Additionally, the enormous growth of decentralized finance infrastructure strains energy grids, raises retail electricity rates, and increases total carbon emissions and local air pollution due to the increasing hardware dedicated for use with performance of electronic transactions and/or other functionality required for decentralized finance systems. Additionally, centralized financial systems are increasingly using similar functionality, thus incurring similar energy and/or computational power costs.

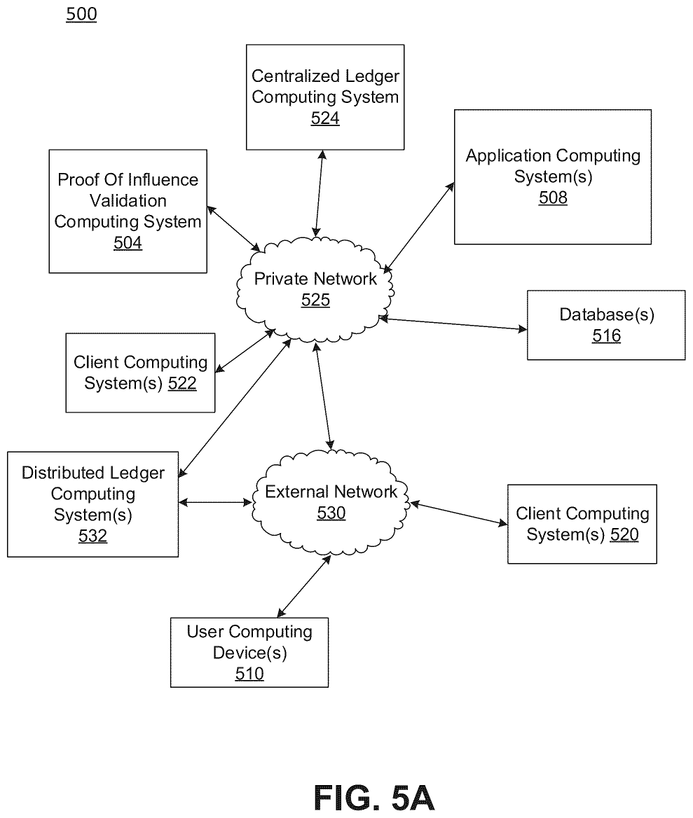

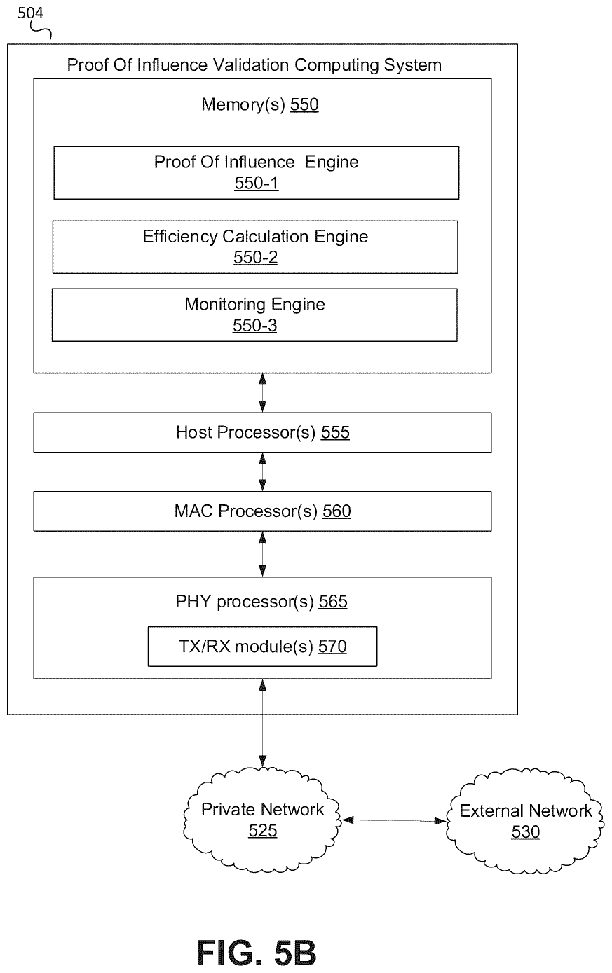

FIG. 5A shows an illustrative computing environment 500 for implementing a proof of influence consensus mechanism, in accordance with one or more arrangements. The computing environment 500 may comprise one or more devices (e.g., computer systems, communication devices, and the like). The computing environment 500 may comprise, for example, a proof of influence validation computing system 504, one or more application computing systems 508, a plurality of user computing devices 510, one or more client computing systems 520 and/or 522, a centralized ledger computing system 524, a distributed ledger computing system 532, and/or one or more database(s) 516. The one or more of the devices and/or systems, may be linked over a private network 525 associated with an enterprise organization (e.g., a financial institution, a business organization, an educational institution, a governmental organization and the like). The computing environment 500 may, for example, comprise a client computing system 520 and one or more user devices 510 connected, via a public network 530, to the devices in the private network 525 and/or the distributed ledger computing system 532 and/or the centralized ledger computing system 524. The devices in the computing environment 500 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.).

The proof of influence validation computing system 504 may comprise one or more computing devices and/or other computer components (e.g., processors, memories, communication interfaces) configured to perform one or more functions as described herein. Further details associated with the architecture of the proof of influence validation computing system 504 are described with reference to FIG. 5B.

The application computing systems 508 and/or the client computing systems 520 and 522 may comprise one or more computing devices and/or other computer components (e.g., processors, memories, communication interfaces). In addition, the application computing systems 508 and/or the client computing systems 520 and 522 may be configured to host, execute, and/or otherwise provide one or more enterprise applications. In some cases, the application computing systems 508 may host one or more services configured facilitate operations requested through one or more API calls, such as data retrieval and/or initiating processing of specified functionality. In some cases, the client computing system 522 and/or 520 may be configured to communicate with one or more of the application computing systems 508 such as via direct communications and/or API function calls and the services. In an arrangement where the private network 525 is associated with a financial institution (e.g., a bank), the application computing systems 508 may be configured, for example, to host, execute, and/or otherwise provide one or more transaction processing programs, such as an online banking application, fund transfer applications, and/or other programs associated with the financial institution. The application computing systems 508 and/or the client computing systems 520 and 522 may comprise various servers and/or databases that store and/or otherwise maintain account information, such as financial account information including account balances, transaction history, account owner information, and/or other information. In addition, the application computing systems 508 and/or the client computing systems 520 and 522 may process and/or otherwise execute transactions on specific accounts based on commands and/or other information received from other computer systems comprising the computing environment 500. In some cases, one or more of the application computing systems 508 and/or the client computing systems 520 and 522 may be configured, for example, to host, execute, and/or otherwise provide one or more transaction processing programs, such as electronic fund transfer applications, online loan processing applications, and/or other programs associated with the financial institution.

The application computing systems 508 may be one or more host devices (e.g., a workstation, a server, and the like) or mobile computing devices (e.g., smartphone, tablet). In addition, an application computing systems 508 may be linked to and/or operated by a specific enterprise user (who may, for example, be an employee or other affiliate of the enterprise organization) who may have administrative privileges to perform various operations within the private network 525. In some cases, the application computing systems 508 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing systems 520 and/or 522 may comprise one or more computing devices and/or other computer components (e.g., processors, memories, communication interfaces). The client computing systems 520 and/or 522 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing systems 520 and/or 522 is for processing an electronic exchange of goods and/or services. The client computing systems 520 and/or 522 may be associated with a specific goods purchasing activity, such as purchasing a vehicle, transferring title of real estate may perform communicate with one or more other platforms within the client computing system 520. In some cases, the client computing systems 520 and/or 522 may integrate API calls to request data, initiate functionality, or otherwise communicate with the one or more application computing systems 508, such as via the services. For example, the services may be configured to facilitate data communications (e.g., data gathering functions, data writing functions, and the like) between the client computing systems 520 and/or 522 and the one or more application systems 508.

The user device(s) 510 may be computing devices (e.g., desktop computers, laptop computers) or mobile computing device (e.g., smartphones, tablets) connected to the network 525. The user device(s) 510 may be configured to enable the user to access the various functionalities provided by the devices, applications, and/or systems in the network 525.

The database(s) 516 may comprise one or more computer-readable memories storing information that may be used by the proof of influence validation computing system 504. For example, the database(s) 516 may store lists of validation computing devices, users of the competitive entertainment computing system, online entertainment platforms or participatory electronic entertainment systems, and the like. In an arrangement, the database(s) 516 may be used for other purposes as described herein. In some cases, the client computing system 520 and/or 522 may write data or read data to the database(s) 516 via the services. Operation of the distributed ledger computing system 532 and/or the centralized ledger computing system 524 may operate according to aspects described above with respect to FIGS. 1-4.

In one or more arrangements, the proof of influence validation computing system 504, the application computing systems 508, the client computing system 522, the client computing system 520, the user devices 510, the centralized ledger computing system 524, the distributed ledger computing system 532 and/or the other devices/systems in the computing environment 500 may be any type of computing device capable of receiving input via a user interface, and communicating the received input to one or more other computing devices in the computing environment 500. For example, the proof of influence validation computing system 504, the application computing systems 508, the client computing system 522, the client computing system 520, the user devices 510, the centralized ledger computing system 524, the distributed ledger computing system 532, and/or the other devices/systems in the computing environment 500 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the proof of influence validation computing system 504, the application computing systems 508, the client computing system 522, the client computing system 520, the user devices 510, the centralized ledger computing system 524, the distributed ledger computing system 532, and/or the other devices/systems in the computing environment 500 may, in some instances, be and/or comprise special-purpose computing devices configured to perform specific functions.

FIG. 5B shows an illustrative proof of influence validation computing system 504 in accordance with one or more examples described herein. The proof of influence validation computing system 504 may be a stand-alone device and/or may at least be partial integrated with the development computing system 504 may comprise one or more of host processor(s) 555, medium access control (MAC) processor(s) 560, physical layer (PHY) processor(s) 565, transmit/receive (TX/RX) module(s) 570, memory 550, and/or the like. One or more data buses may interconnect host processor(s) 555, MAC processor(s) 560, PHY processor(s) 565, and/or Tx/Rx module(s) 570, and/or memory 550. The proof of influence validation computing system 504 may be implemented using one or more integrated circuits (ICs), software, or a combination thereof, configured to operate as discussed below. The host processor(s) 555, the MAC processor(s) 560, and the PHY processor(s) 565 may be implemented, at least partially, on a single IC or multiple ICs. The memory 550 may be any memory such as a random-access memory (RAM), a read-only memory (ROM), a flash memory, or any other electronically readable memory, or the like.

Messages transmitted from and received at devices in the computing environment 500 may be encoded in one or more MAC data units and/or PHY data units. The MAC processor(s) 560 and/or the PHY processor(s) 565 of the proof of influence validation computing system 504 may be configured to generate data units, and process received data units, that conform to any suitable wired and/or wireless communication protocol. For example, the MAC processor(s) 560 may be configured to implement MAC layer functions, and the PHY processor(s) 565 may be configured to implement PHY layer functions corresponding to the communication protocol. The MAC processor(s) 560 may, for example, generate MAC data units (e.g., MAC protocol data units (MPDUs)), and forward the MAC data units to the PHY processor(s) 565. The PHY processor(s) 565 may, for example, generate PHY data units (e.g., PHY protocol data units (PPDUs)) based on the MAC data units. The generated PHY data units may be transmitted via the TX/RX module(s) 570 over the private network 525. Similarly, the PHY processor(s) 565 may receive PHY data units from the TX/RX module(s) 565, extract MAC data units encapsulated within the PHY data units, and forward the extracted MAC data units to the MAC processor(s). The MAC processor(s) 560 may then process the MAC data units as forwarded by the PHY processor(s) 565.

One or more processors (e.g., the host processor(s) 555, the MAC processor(s) 560, the PHY processor(s) 565, and/or the like) of the proof of influence validation computing system 504 may be configured to execute machine readable instructions stored in memory 550. The memory 550 may comprise (i) one or more program modules/engines having instructions that when executed by the one or more processors cause the proof of influence validation computing system 504 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the proof of influence validation computing system 504 and/or by different computing devices that may form and/or otherwise make up the proof of influence validation computing system 504. For example, the memory 550 may have, store, and/or comprise a proof of influence engine 550-1, an efficiency calculation engine 550-2, a monitoring engine 550-3, and/or the like. The proof of influence engine 550-1 may have instructions that direct and/or cause the proof of influence validation computing system 504 to perform one or more operations associated with generating influence scores and/or efficiency scores associated with one or more validators (e.g., validation computing equipment) and/or causing a proof of work engine to generate computational algorithms associated with an influence score for the one or more validators, and the like. The efficiency calculation engine 550-2 may have instructions that may cause the proof of influence validation computing system 504 to calculate energy efficiency and/or computation efficiency associated with computing equipment associated with block validation activities, and the like. The monitoring engine 550-3 may have instructions that may cause the proof of influence validation computing system 504 to perform one or more operations associated with interfacing with monitoring block validation activities for one or more validators and/or monitoring a status of wallets associated with the one or more validators such as to identify successful block validations and/or to determine whether wallets associated with each validators are clean wallets or dirty wallets, and the like.

While FIG. 5A illustrates the proof of influence validation computing system 504 and/or the application computing systems 508, as being separate elements connected in the private network 525, in one or more other arrangements, functions of one or more of the above may be integrated in a single device/network of devices. For example, elements in the proof of influence validation computing system 504 (e.g., host processor(s) 555, memory(s) 550, MAC processor(s) 560, PHY processor(s) 565, TX/RX module(s) 570, and/or one or more program/modules stored in memory(s) 550) may share hardware and software elements with and corresponding to, for example, the application computing systems 508.

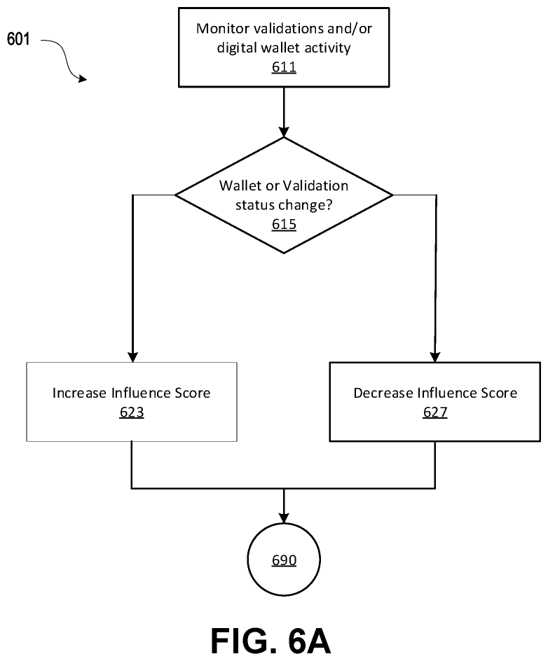

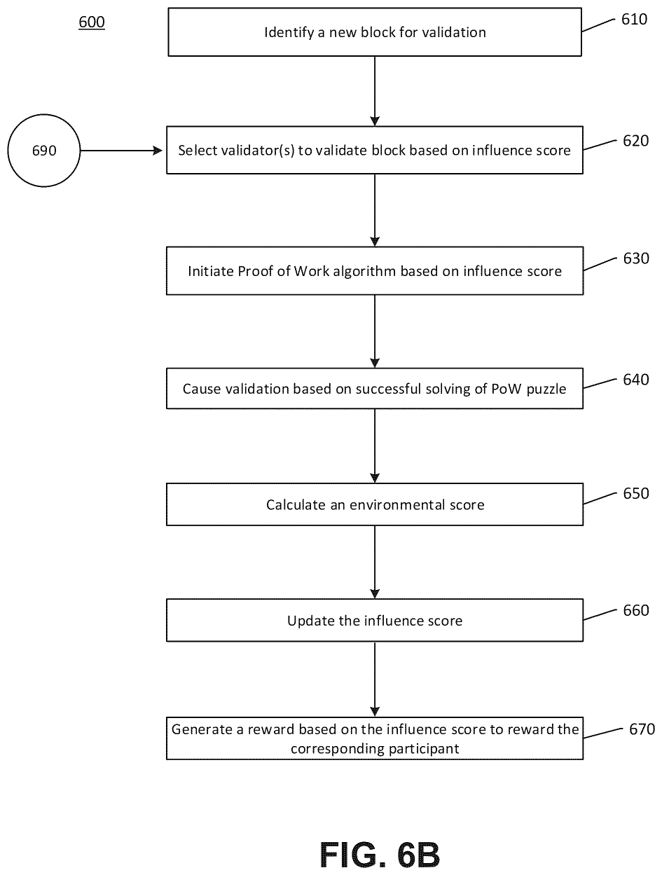

FIGS. 6A and 6B show an illustrative process for a proof of influence consensus mechanism, in accordance with one or more aspects described herein. For example, FIG. 6A shows a method 601 for updating an influence score associated with one or more validators (e.g., validator computing devices such as the user computing devices 510). At 611, the monitoring engine 550-3 may monitor activities associated with the one or more validators to identify whether one or more validators participating in validation activities for one or more new blocks of one or more blockchains and/or similar distributed or centralized ledgers. The monitoring engine 550-3 may also monitor activities and/or classifications associated with digital wallets associated with the one or more user computing devices 510 and/or otherwise associated with one or more validators. For example, the monitoring engine 550-3 may identify digital wallet activities associated with a “clean” digital wallet and/or with a “dirty” digital wallet. For example, clean digital wallets are associated with known good distributed ledger activities and/or validated digital currencies. Dirty digital wallets may be found to be associated with one or more illicit digital activities such as dark web transactions, crypto crimes and/or exchange hacks, attempts to hide the proceeds of illicit activities by converting them into crypto-based currencies, participation in fraudulent schemes and/or projects, and/or other malicious or illicit activities. If, at 615, the monitoring engine 550-3 identifies a wallet status change and/or a validation activity status change associated with one or more validators (e.g., the user computing devices 510), the monitoring engine 550-3 may trigger the proof of influence engine 550-1 to modify an influence score associated with one or more validators. For example, if a wallet activity reinforces and/or improves a wallet “reputation”, the proof of influence engine 550-1 may increase a reputation score at 625. Additionally, or alternatively, if a validator successfully validates a new block, the proof of influence engine 550-1 may increase a reputation score at 625. If, at 625, the monitoring engine 550-3 identifies an indication that a digital wallet associated with one or more validators, such as an indication of an association with illegal or fraudulent use, the proof of influence engine 550-1 may decrease an associated reputation score at 627. Additionally, or alternatively, if a validator is unsuccessful when attempting to validate a new block, the proof of influence engine 550-1 may decrease a reputation score at 625. In an illustrative example, the proof of influence engine 550-1 may utilize an algorithm to base the increase or decrease of the influence score via a weighted sum, such as I_{score}=I_{score}+w₁*Xᵥₐₗ+w₂*y_{wal}, where I_{score} is the current influence score value (or seed value for an initial iteration), w₁ and w₂ are weighting values that may be positive for an increasing influence score event or negative for a decreasing influence score event, and xᵥₐₗ and y_{wal} are influence score values associated with a particular validation event (xᵥₐₗ) and a particular digital wallet event (y_{wal}). Once the influence score is updated either up or down, the proof of influence engine 550-1 uses the influence score in the proof of influence process 600 of FIG. 6B

FIG. 6B shows an illustrative process for a proof of influence consensus mechanism. At 610, the proof of influence engine 550-1 identifies when a new block is available for validation to be added to the distributed ledger (e.g., a block chain, a Holochain, and the like). At 620, the proof of influence engine 550-1 selects one or more validators to validate the new block based on an influence score, where the influence score may be continuously updated via the method 601 of FIG. 6A. At 630, once the proof of influence engine 550-1 selects the one or more validators, the proof of influence engine 550-1 initiates a proof of work algorithm based on the associated influence scores, where highly reliable validators (e.g., a high influence score) are assigned an easier algorithm to solve and validators with lower influence scores are assigned harder algorithms to solve.

At 650, the proof of influence engine 550-1 may then initiate a block validation sequence to add the validated block to the associated distributed ledger based on a successful validation, such as a successful solving of a proof of work puzzle. At 650, the efficiency calculation engine 550-2 calculates an efficiency score for the winning validator, based on an energy efficiency calculation and/or a computational efficiency calculation. Once calculated, the proof of influence engine 550-1 may then use the efficiency score to calculate an update of the influence score. For example, the efficiency score may be based on a calculated energy efficiency and/or a calculated computation efficiency for the successful validator, where the efficiency score may be a weighted sum of the calculated energy efficiency and computational efficiency. In some cases, the efficiency scores may be increased or decreased based on an average efficiency (computational and/or energy) of the particular validator, a most efficient validator, an average efficiency for two or more validators, and/or the like. At 670, the proof of influence engine 550-1 may then generate a reward based on the influence score to reward the corresponding validator.

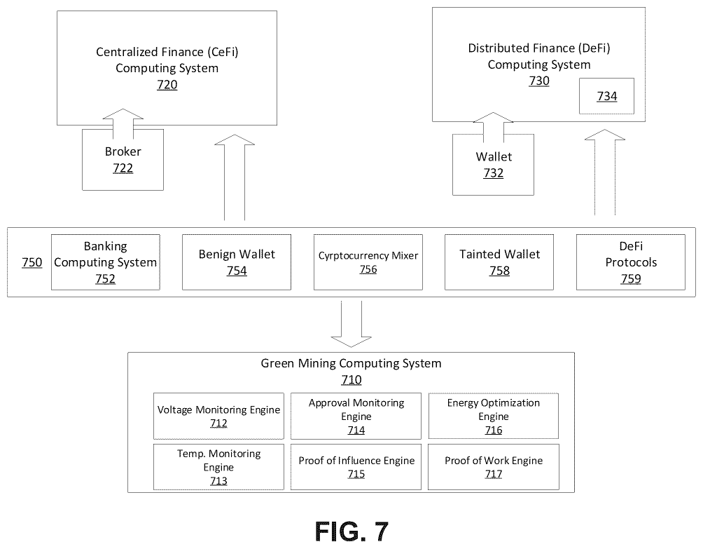

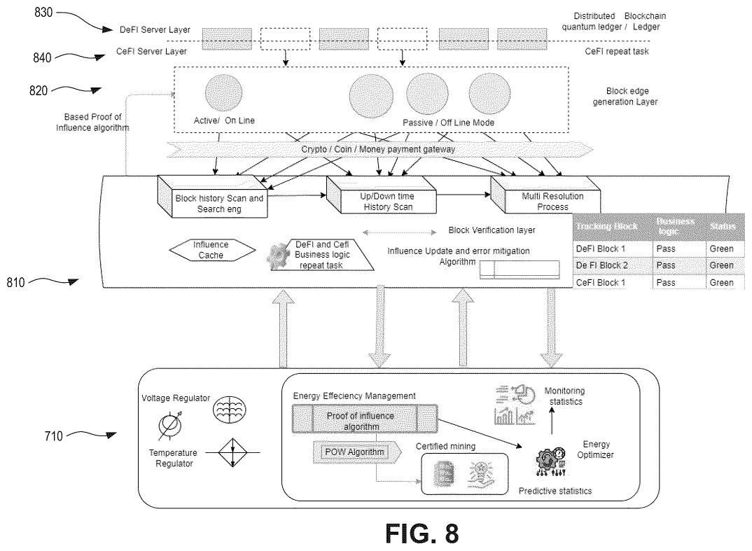

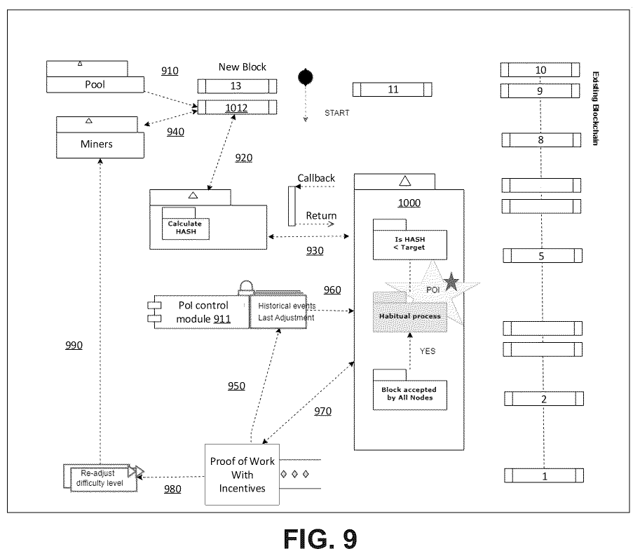

FIG. 7 shows an illustrative proof of influence consensus mechanism computing system and FIGS. 8 and 9 show aspects of an illustrative proof of influence consensus mechanism in accordance with one or more aspects described herein. The proof of influence consensus mechanism computing system works on protocol called proof of influence (Pol) where the green mining methodologies are incorporated in distributed quantum ledger-based decentralized finance ecosystems, in decentralized financial systems and/or centralized financial systems, and the like. The proof of influence algorithm enables miners to accumulate and use reputation points to reduce computational power requirements on their systems and/or reduce energy consumptionInfluence points is an indicator of trustworthiness of the miner established based utilizing a predictive algorithm that analyzes the past mining behavior. Higher reputational scores result in lesser computationally intensive activities, which reduce energy consumption. The proof of influence algorithm rewards miners to encourage participation as validators of new blocks and/or other activities on the decentralized or centralized ledger-based systems. The Pol algorithm influences the trustworthy person (e.g., a miner, a validator, and the like) participating in a chain of multiple blocks of transactions, such as block chain and/or holochain. This reward system accumulates the rewards in the form of stable coins, that can used for the remittance and/payouts. Pol offers a promising solution to reduce the overall carbon footprint generated due to intensive compute usage at data centers (and edge devices) catering to distributed quantum ledger frameworks.

Decentralized finance (DeFi) refers to a set of newly emerging financial products and services that operate on decentralized platforms using blockchains (or other distributed ledger systems such as holochain) to record and share data. A DeFi computing system 720 may facilitate DeFi products and services are conducted without a trusted central intermediary such as a bank. Centralized finance (CeFi) refers to the traditional financial system 730 where financial services are controlled by centralized institutions such as banks, governments, and other financial intermediaries. Within the DeFi system, a distributed ledger, (e.g., a distributed quantum ledger 734) may be integrated within the DeFi system to facilitate a recording of secure and immutable financial records, such as within a blockchain, holochain, or other similar technology. The distributed quantum ledger 734 is a type of blockchain technology that combines quantum computing with distributed ledger technology. It aims to leverage the power of quantum computing to create a more secure and scalable decentralized system. In addition to speed, distributed quantum ledger would also be more secure than traditional blockchains. The process and decisions for facilitating electronic transactions may be facilitated in a transaction layer 750, or via other channels, such as via a broker 722 or various digital wallets 732. The financial transaction layer 750 may include interfaces to facilitate financial transactions carried out in centralized finance by a central financial organization, whereas in decentralized finance, the transactions are done by the peer network, that requires cryptocurrency mining process. For example, the financial transaction layer 750 may include various electronic transaction mechanisms, either legitimate or designed to facilitate malicious or fraudulent transactions. For example, the financial transaction layer 750 may include a banking computing system 752, a benign wallet 754, a cryptocurrency mixer 756, a tainted wallet 758, and/or one or more computing devices leveraging various DeFi protocols. The DeFi computing interfaces may include of benign wallets and tainted wallets, where a benign wallet is legal and clean and not associated with any questionable transactions. While, a tainted wallet may be associated with one or more electronic transactions associated with illegal and/or fraudulent activities.

The green mining computing system 710 may include a voltage monitoring engine 712, a temperature monitoring engine 713, an approval monitoring engine 714, a proof of influence engine 715, an energy optimization engine 716, and a proof of work monitoring engine 717. The green mining computing system 710 may integrate these computing engines facilitating use of the Proof of Influence (Pol) algorithm that is built over the Proof of Work (PoW) algorithm. The Pol algorithm works by comparing the past mining behavior on basis of predictive algorithm, that aims to reduce the carbon prints of associated computing devices, where the carbon footprint of computing devices increases enormously in DeFi transactions. The voltage monitoring engine 712 and/or the temperature monitoring engine 713 may be remotely installed, or include remote components, configured for monitoring operation of validator computing devices wile performing proof of work operations. In some cases, a centralized voltage monitoring engine 712 and/or a centralized temperature monitoring engine 713 may monitor computing operations and/or efficiencies of each validator computing device. A Proof of Work is an algorithm used in DeFi systems to validate transactions, where the miners solve complex mathematical puzzles using computational power and validate the block to receive a reward in the form of cryptocurrency. Certified mining is carried out by validating and verifying cryptocurrency transactions on blockchain network, which is done by certified or approved miners who meet certain qualifications/criteria set by the network, and are implemented through a mechanism where miners are evaluated based on their past performance and track-record. The approval monitoring engine may monitor efficiencies of each approved block added to a ledger (e.g., a centralized ledger, a distributed ledger) to identify which validator approved the block, which validators were attempting to validate the block and failed, and communicate this information and/or efficiency information from the voltage monitoring engine 712 and the temperature monitoring engine 713 to the proof of influence engine 715 to update via a proof of influence algorithm, an indicator of a complexity associated with each validator, where the proof of work monitoring engine 717 uses the indicators of complexity to generate proof of work puzzles for each validator based on a unique complexity associated with each validator. The energy optimization engine 719 further uses proof of influence data to predict energy usage statistics associated with each validator computing device based on complexity parameter values associated with corresponding validators. The predicted efficiency statistics are further incorporated into the proof of influence algorithm by the proof of influence engine 715 to adjust the complexities, such as by adjusting a weighting value applied to voltage statistic usage and/or temperature trending information.

FIG. 8 shows another view of the Pol enabled computing system and interactions performed during a process of validating blocks added to ledgers. The process is conceptualized to take place in the centralized finance system (e.g., a CeFi layer 840) as well as in decentralized finance system (e.g., a DeFi layer 830). Also, the functionality may utilize the scan search block engine where all the previous transaction data is being stored, such as a transaction layer 820. All the transactions are logged in to the History Scan search engine block. At each step, comparison is being carried out to analyze the past behavior in the History block to validate with the current process on the basis of Predictive algorithm implementation. The process also is parallelly subject to the multi-resolution processing, that breaks down the data stored into multiple layers of different resolutions, with each layer representing a different level of abstraction, which is analyzed and processed more efficiently. It makes identifying the anomalies easier that might not be when looking at data as a whole. The above steps are based on the proposed Proof of Influence Algorithm, built over the conventional Proof of Work algorithm that focuses on bringing down the energy consumptions during burning of cryptocurrency and intensive mining process as integrated into the green mining computing system 710 and/or a proof of influence application layer 810 configured to enable application of Pol functionality to blocks awaiting validation.

FIG. 9 shows an illustrative process where a new block 1012 is selected at 910 from a pool of available blocks, where a hash associated with the block is calculated at 920 for use with the proof of work algorithm. At 930, the hash is calculated by the proof of work engine based on complexity values associated with each validator (e.g., miners) who begin solving their associated puzzles at 1000 after being assigned at 940. Each miner may be assigned a different logical puzzle to solve based on an associated complexity level assigned by the proof of influence engine. At 950, the Pol control module 911 receives proof of work information and associated incentive information assigned to each miner and monitors the validation process at 960. At 970, the proof of work engine receives monitoring information regarding solving of the puzzles, efficiency information from each computing device involved, and weighting information for the complexity for puzzles generated for each validator to calculate adjustments to difficulty levels based on historical operation of each validation computing device, including identifying whether digital wallets associated with each validator have been identified as being clean wallets or suspected of being dark wallets. At 980, a difficulty level is adjusted based on implementation of the Pol algorithm based on the information and incentives (e.g., cryptocurrency) are awarded to one or more validators (e.g., by depositing an amount of cryptocurrency into a digital wallet). In some cases, the incentives are awarded based on successfully validating the new block and/or for improving energy efficiency or computational efficiency during the process. At 990, the difficulty levels associated with each validator is adjusted.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system comprising:
a ledger computing system comprising a blockchain;
a plurality of validator computing devices, wherein each validator computing device of the plurality of validator computing devices is associated with the ledger computing system; and
a proof of influence validation system comprising:
one or more processors, wherein each processor of the one or more processors is associated with one or more different devices; and
non-transitory memory storing instructions that when executed by the one or more processors, cause the proof of influence validation system to:
select, based on an influence value associated with a user corresponding to each validator computing device of the plurality of validator computing devices, a first number of validator computing devices of the plurality of validator computing devices;
generate, based on a complexity parameter associated with each validator computing device of the first number of validator computing devices and by a proof of work engine, a logical puzzle for solving by each validator computing device of the first number of validator computing devices, wherein the complexity of the logical puzzle is unique to a corresponding validator computing device;
identify, based on an indication that a winning validator computing device has solved its associated logical puzzle, an incentive to be awarded, wherein the incentive comprises an amount of cryptocurrency; and
trigger, based on the identification of the incentive, transfer of the incentive to a digital wallet associated with the winning validator computing device.

2. The system of claim 1, wherein the ledger computing system comprises a distributed ledger computing system comprising a blockchain.

3. The system of claim 1 wherein the ledger computing system comprises a distributed quantum ledger.

4. The system of claim 1, wherein the ledger computing system comprises a centralized ledger.

5. The system of claim 1, wherein the instructions further cause the proof of influence validation computing system to:
receive, via a network, energy efficiency statistical information from each validation computing device of the plurality of validation computing devices; and
calculate, based on the energy efficiency statistical information, updated complexity parameters.

6. The system of claim 1, wherein the incentive corresponds to a determined efficiency of the winning validator computing device while solving the logical puzzle.

7. The system of claim 1, wherein the instructions further cause the proof of influence validation computing system to recalculate the complexity parameter based on a digital reputation score associated with each validation computing device of the plurality of validation computing devices, wherein the reputation score corresponds to a reputation status of a digital wallet associated with corresponding users of each validation computing device of the plurality of validation computing devices.

8. The system of claim 7, wherein the reputation status of a digital wallet corresponds to whether the digital wallet is classified as one of a benign digital wallet and a tainted digital wallet.

9. A computing platform comprising:
one or more processors, wherein each processor of the one or more processors is associated with one or more different devices; and
non-transitory memory storing instructions that when executed by the one or more processors, cause a proof of influence validation system to:
select, based on an influence value associated with a user corresponding to each validator computing device of a plurality of validator computing devices, a first number of validator computing devices of the plurality of validator computing devices;
generate, based on a complexity parameter associated with each validator computing device of the first number of validator computing devices and by a proof of work engine, a logical puzzle for solving by each validator computing device of the first number of validator computing devices, wherein the complexity of the logical puzzle is unique to a corresponding validator computing device;
identify, based on an indication that a winning validator computing device has solved its associated logical puzzle to add a new block to a digital ledger stored on a ledger computing system, an incentive to be awarded, wherein the incentive comprises an amount of cryptocurrency; and
trigger, based on the identification of the incentive, transfer of the incentive to a digital wallet associated with the winning validator computing device.

10. The computing platform of claim 9, wherein the ledger computing system comprises a distributed ledger computing system comprising a blockchain.

11. The computing platform of claim 9, wherein the ledger computing system comprises a distributed quantum ledger.

12. The computing platform of claim 9, wherein the ledger computing system comprises a centralized ledger.

13. The computing platform of claim 9, wherein the instructions further cause the proof of influence validation computing system to:
receive, via a network, energy efficiency statistical information from each validation computing device of the plurality of validation computing devices; and
calculate, based on the energy efficiency statistical information, updated complexity parameters.

14. The computing platform of claim 9, wherein the incentive corresponds to a determined efficiency of the winning validator computing device while solving the logical puzzle.

15. The computing platform of claim 9, wherein the instructions further cause the proof of influence validation computing system to recalculate the complexity parameter based on a digital reputation score associated with each validation computing device of the plurality of validation computing devices, wherein the reputation score corresponds to a reputation status of a digital wallet associated with corresponding users of each validation computing device of the plurality of validation computing devices.

16. The computing platform of claim 15, wherein the reputation status of a digital wallet corresponds to whether the digital wallet is classified as a benign digital wallet or a tainted digital wallet.

17. A method comprising:
selecting, based on an influence value associated with a user corresponding to each validator computing device of a plurality of validator computing devices, a first number of validator computing devices of the plurality of validator computing devices;
generating, based on a complexity parameter associated with each validator computing device of the first number of validator computing devices and by a proof of work engine, a logical puzzle for solving by each validator computing device of the first number of validator computing devices, wherein the complexity of the logical puzzle is unique to a corresponding validator computing device;
identifying, based on an indication that a winning validator computing device has solved its associated logical puzzle to add a new block to a digital ledger stored on a ledger computing system, an incentive to be awarded, wherein the incentive comprises an amount of cryptocurrency; and
triggering, based on the identification of the incentive, transfer of the incentive to a digital wallet associated with the winning validator computing device.

18. The method of claim 17, further comprising recalculating the complexity parameter based on a digital reputation score associated with each validation computing device of the plurality of validation computing devices, wherein the reputation score corresponds to a reputation status of a digital wallet associated with corresponding users of each validation computing device of the plurality of validation computing devices.

19. The method of claim 17 further comprising:
receiving, via a network, energy efficiency statistical information from each validation computing device of the plurality of validation computing devices; and
calculating, based on the energy efficiency statistical information, updated complexity parameters.

20. The method of claim 17, wherein the incentive corresponds to a determined efficiency of the winning validator computing device while solving the logical puzzle.
